(19) United States
(12) Patent Application Publication
(10) Pub. No.: US 2023/0351304 A1
(43) Pub. Date: Nov. 2, 2023

(54) METHOD AND SYSTEM FOR IMPROVEMENT PROFILE GENERATION IN A SKILLS MANAGEMENT PLATFORM

(71) Applicant: GENESYS CLOUD SERVICES, INC., MENLO PARK, CA (US)

(72) Inventor: JAMIE DELO, SOLIHULL (GB)

(73) Assignee: GENESYS CLOUD SERVICES, INC., MENLO PARK, CA (US)

(21) Appl. No.: 18/219,297

(22) Filed: Jul. 7, 2023

Related U.S. Application Data
(63) Continuation of application No. 16/596,840, filed on Oct. 9, 2019.

(51) Int. Cl. G06Q 10/0639; G06Q 10/0631

(52) U.S. Cl. CPC G06Q 10/06393; G06Q 10/063112; G06Q 10/06395; G06Q 10/06398

(57) ABSTRACT

A system and method are presented for improvement profile generation in a skills management platform, using past data and a set of KPIs. Variance calculation is performed with a basic variance formula and these values are used to generate a strand. A strand may be defined as a collection of KPIs, each weighted to show the importance of that KPI for that agent type. KPIs can be selected to generate a strand with, and the strand is generated from those KPIs considering the normalized variance of each KPI. An agent's improvement possibilities may also be determined using the generated strand.

### CROSS REFERENCE TO RELATED APPLICATION

This application claims the benefit and is a continuation of U.S. patent application Ser. No. 16/596,840 titled “METHOD AND SYSTEM FOR IMPROVEMENT PROFILE GENERATION IN A SKILLS MANAGEMENT PLATFORM”, filed in the U.S. Patent and Trademark Office on Oct. 9, 2019, the contents of which are incorporated herein by reference.

### BACKGROUND

The present invention generally relates to telecommunications systems and methods, as well as contact center staffing More particularly, the present invention pertains to determining skills for improvement for contact center staffing.

### SUMMARY

A system and method are presented for improvement profile generation in a skills management platform, using past data and a set of KPIs. Variance calculation is performed with a basic variance formula and these values are used to generate a strand. A strand may be defined as a collection of KPIs, each weighted to show the importance of that KPI for that agent type. KPIs can be selected to generate a strand with, and the strand is generated from those KPIs considering the normalized variance of each KPI. An agent's improvement possibilities may also be determined using the generated strand.

In one embodiment, a method is presented for improvement profile generation and automatically generating strands of key performance indicators associated with a given agent in a contact center environment using a skills management platform, the method comprising the steps of: determining a variance of each desired metric using a variance formula and past data for the desired metric; normalizing the determined variances against other metrics associated with the agent and determine the importance of each metric; generating the strand through the skills management platform; determining distance from a mean for each desired metric for the agent, wherein distances not meeting a threshold are selected for improvement for the agent; comparing the resulting distances for the agent with those of other agents in the contact center; and generating the improvement profile, wherein the other agents are ranked with suggestions provided on improvement metrics for each agent through a user interface associated with the skills management platform.

The importance is based on weightings applied to each metric depending on ranking by a user. Metrics with a higher variance have a stronger weighting than metrics with a smaller variance. The selection comprises considering potential gain and difficulty of improvement of the metric. The determination comprises mathematically calculating the minimum over the set of metrics for the agent to determine which metric needs improvement. The variance formula comprises dividing a squared sum of the past data by the same size and removing the mean of the past data.

In another embodiment, a method is presented for profile generation and automatically generating strands of key performance indicators associated with a given agent in a contact center environment using a skills management platform, the method comprising the steps of: determining a variance of each desired metric using a variance formula and past data for the desired metric; normalizing the determined variances against other metrics associated with the agent and determine the importance of each metric; generating the strand through the skills management platform; determining distance from a mean for each desired metric for the agent, wherein distances are selected for highlighting agent performance against the metric; comparing the resulting distances for the agent with those of other agents; and generating the profile, wherein the other agents are ranked and presented to a user through a user interface associated with the skills management platform.

In another embodiment, a system is presented for improvement profile generation and automatically generating strands of key performance indicators associated with a given agent in a contact center environment using a skills management platform, the system comprising: a processor; and a memory in communication with the processor, the memory storing instructions that, when executed by the processor, causes the processor to generate an improvement profile wherein agents are ranked with suggestions provided on improvement metrics for each agent through a user interface associated with the skills management platform by: determining a variance of each desired metric using a variance formula and past data for the desired metric; normalizing the determined variances against other metrics associated with the agent and determine the importance of each metric; generating the strand through the skills management platform; determining distance from a mean for each desired metric for the agent, wherein distances not meeting a threshold are selected for improvement for the agent; and comparing the resulting distances for the agent with those of other agents in the contact center.

In another embodiment, a system is presented for profile generation and automatically generating strands of key performance indicators associated with a given agent in a contact center environment using a skills management platform, the system comprising: a processor; and a memory in communication with the processor, the memory storing instructions that, when executed by the processor, causes the processor to generate an improvement profile wherein agents are ranked and presented to a user through a user interface associated with the skills management platform by: determining a variance of each desired metric using a variance formula and past data for the desired metric; normalizing the determined variances against other metrics associated with the agent and determine the importance of each metric; generating the strand through the skills management platform; determining distance from a mean for each desired metric for the agent, wherein distances are selected for highlighting agent performance against the metric; and comparing the resulting distances for the agent with those of other agents.

### BRIEF DESCRIPTION OF THE DRAWINGS

FIG. 1 is a diagram illustrating an embodiment of a skills data processing system.

FIG. 2 is a flowchart illustrating an embodiment of a process for providing mapping data to information providers.

FIG. 3 is a table illustrating an example of a random sample data set.

FIG. 4 is a table illustrating an example of determination of a strand.

FIG. 5 is a table illustrating an example of performance determination.

FIG. 6A is a diagram illustrating an embodiment of a computing device.

FIG. 6B is a diagram illustrating an embodiment of a computing device.

### DETAILED DESCRIPTION

For the purposes of promoting an understanding of the principles of the invention, reference will now be made to the embodiment illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

Different employees often have different skill sets (e.g., technically proficient, sales experience, multi-lingual, etc.) and employees with the same or similar skill sets (e.g., employees with the same job duties) may have varying degrees of competence with respect to particular skills within their skill sets. Defining employee skill sets and establishing measures of competency in or performance of the various skills in the skill sets can allow employers to better utilize their employees and allow employees to develop new skills or enhance their existing skills. For example, if employee X is highly articulate, well-versed in South American culture and fluent in Portuguese, then that employee is likely a better fit for a sales position in Brazil than English-only speaking employee Y with no previous sales experience. Further, by assigning employee X to the sales position, the employer is likely to benefit from employee X being more effective in the sales position than employee Y based on the match between employee X's skill set and the demands of the sales position.

Likewise, if an employer has two employees with similar skill sets and the employer needs to assign one employee to service its flagship client, then the employer may need to know which of the two employees is the best performer (e.g., as determined by comparing the skills, competencies or performance of the employees) so that the employer can assign the employee to the client. However, effectively defining and evaluating employee skill sets, and aligning employees having particular skill sets to the demands of particular jobs is not a trivial task. Related U.S. Pat. No. 8,589,215, titled “WORK SKILLSET GENERATION”, issued Nov. 19, 2013, describes methods, software and systems for generating mapping data and correlation data based on service provider data. However, the embodiments described therein require a user of the system to create strands used in the methods, software and systems manually by determining the weighting of each Key Performance Indicator (KPI) and building the strands from scratch. This is very time and labor intensive. By generating the strands automatically, setup of the system is shortened. An automatic approach is described in the embodiments herein.

A KPI comprises a value indicating the performance of an agent in a field (e.g. Average Handling Time). In a contact center environment, KPIs may be used to compare agents in performance areas. Strands comprise collections of these KPIs, each weighted to show the importance of that KPI for that agent type. Each agent type would have its own strand, with each one having differing KPIs and weightings. For example, the agent type ‘Sales’ might have its own strand consisting of the KPIs: sales per hour (30%), Average Sale Value (50%), and Average Handle Time (20%). This example illustrates that the three KPIs (sales per hour, average sale value, and average handle time) are what determine how good an agent is in sales. This example also determines how each of those KPIs influence the total score with their respective weightings of 30%, 50%, and 20%. In general, strands allow a user of the system to rate agents based on important metrics automatically and identify where agents can improve the most.

In another embodiment, examination of the variance in agent performance for a KPI allows for direct agent comparison, rating the potential for a performance increase by an agent, and comparison of sets of agents. High variance across a dataset might infer that low performers may need additional training to reach the levels of the higher performers. A low variance in a dataset might indicate that, even in bad performers, there may be little room for improvement or possible growth without considerable effort.

Skills Data Processing Systems

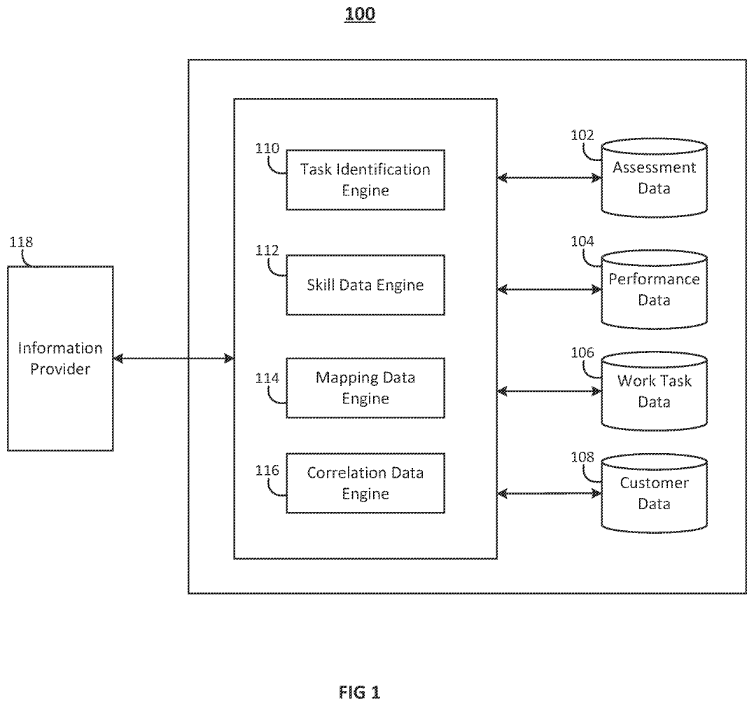

FIG. 1 is a diagram illustrating an embodiment of a skills data processing system, indicated generally at 100. The skills data processing system 100 can receive and process performance data and assessment data to generate skills data, and can generate mapping data and correlation data based on the skills data, as described in more detail below. The skills data processing system 100 is typically implemented in computer servers and can provide and receive data over a network. Example networks include local area networks (LANs), wide area networks (WANs), telephonic networks, and wireless networks. In an embodiment, the skills data processing system 100 may be implemented in a contact center environment, or in an enterprise environment where the managing of employee skills, knowledge and attributes can be correlated with the business performance.

In some implementations, the skills data processing system 100 includes an assessment data store 102, a performance data store 104, a work task data store 106, and a customer data store 108. Although depicted as separate data stores, the data for each of the data stores 102, 104, 106, and 108 can be stored in a single data store, e.g., such as in a relational database, or any other appropriate storage scheme.

The assessment data store 102 stores assessment data. As described above, assessment data specify subjective measures of employee or job role attributes. For example, the subjective measures can be based on a scale (e.g., 1 to 10 with 10 being the highest measure and 1 being the lowest measure) or be more abstract classifications such as, for example, ‘poor’, ‘good’ or ‘exceptional’. However, other ranking or classification methods are also possible. The attributes can be, for example, related to selling skills, customer service skills, job completion timeliness, prioritization ability, work product quality, or any other attribute or characteristic of an employee or job role. Thus, for example, the assessment data may specify that a particular customer service representative has above average customer service skills and average prioritization abilities. The assessment data may also specify that employee X has an average selling skill measure of three on a ten-point scale, as ranked by two supervisors of employee X (one supervisor providing a ranking of 2 and the other supervisor providing a ranking of 4). Not only can assessment data be generated for a service provider (e.g., employee) by others (e.g., manager), assessment data can also be generated by the service provider being evaluated, e.g., self-assessments.

The performance data store 104 stores performance data. As described above, performance data specify objective measures of performance metrics. The objective measures are, for example, identified or derived from any measured or other unbiased classification of the performance of a work task (e.g., performance metric) such that the objective measure does not vary based on the person(s) reporting the data. Performance data can specify, for example, that employee W transferred four customer service calls to other customer service representatives last week (i.e., the performance metric is the number of calls transferred and the objective measure is four transferred calls). The number of calls transferred is not subject to the vagaries of individual interpretation—e.g., it can be verified from the call transfer log that four calls were transferred. In another example, performance data specify that employee Y, who is a customer service representative, received a 92% customer service feedback score based on surveys ranking various aspects of employee Y's performance during service calls. The results of the surveys are verifiable (e.g., if customer A ranked employee Y as a “3” then regardless of who reports the survey results, the ranking remains a “3”). In yet another example, the performance data may specify that an employee completed a training course.

The work task data store 106 stores work task data specifying work tasks for service providers (e.g., work-related tasks of an employee such as a call center employee or work-related tasks generally describing a job position). Work tasks are any type of job, job duty, aspect of a job or any other type of activity or function such as selling products, manufacturing goods, supervising others, handling service calls, repairing electronics, etc. In some implementations, a set of one or more work tasks can generally describe a job role or position, or can describe a particular employee's job duties or responsibilities.

The customer data store 108 stores customer data specifying work tasks requested by particular customers (e.g., a customer of a call center company employing the call center to handle its customer support calls or to contact prospective purchasers of the customer's products). Different customers can have different work task requirements or requests. For example, customer A may be a manufacturer using a call center to handle technical support service calls (i.e., the work task) and customer B may be an insurance provider using the call center to provider sales services for various insurance offerings for the insurance provider (i.e., the work task).

The customer data can also specify certain customer required or desired attributes or performance levels associated with the requested work tasks. For example, customer A may specify that only call center employees (e.g., service providers) having at least two years' experience in providing technical support over the phone handle its calls and customer B may specify that only call center employees having particular investment credentials (e.g., having obtained an industry certification) handle its calls. Further, in addition to specifying that employees must have two years' experience in providing technical support over the phone, the customer data can also specify that customer A requires the employees to have a bachelor's degree in mechanical engineering. Likewise, for customer B, the customer data can also specify that customer B requires the employees to be conversationally fluent in Spanish.

The skills data processing system 100 also includes a task identification engine 110, a skills data engine 112, a mapping data engine 114, and a correlation data engine 116. The task identification engine 110 is configured to receive work task data specifying work tasks for service providers (e.g., customer service employees of a call center company). The specific architecture shown in FIG. 1 is but one example implementation, and other function distributions and software architectures can be used. Each engine is respectively defined by corresponding software instructions that cause the engine to perform the functions and algorithms described below.

The task identification engine 110 receives the work task data from an employer of the service provider describing the job duties, capabilities and/or competencies of the service provider. In some implementations, the work task data is provided from a database containing work history, credentials and the like of various service providers (e.g., an employment database).

The skills data engine 112 is configured to generate skills data for each service provider based on received assessment data and the performance data associated with the performance of work tasks by the service provider. In some implementations, the assessment data and the performance data are received, for example, from the service provider (e.g., self-surveys), the employer of the service provider, or both. The skills data define a skillset of the service provider for the performance of one or more work tasks.

A skillset is a representation of the skills of a service provider. The skillset includes an aggregation of the performance data and assessment data of the service provider with respect to the performance of certain work tasks. Thus, the skillset represents skills of the service provider (e.g., the abilities, aptitudes, competencies, deficiencies, and the like, of a service provider). For example, the skillset of a service provider (e.g., employee John Smith) can represent that the service provider is a customer service representative with product sales experience. Based on the objective and subjective measures specified by the performance data and assessment data, respectively, the skillset can also represent how well or poorly the service provider performed the work tasks (e.g., an employee performance review). For example, the skillset can represent that the service provider achieved 92% of the service provider's sales goal last year (e.g., based on the performance data). The skills data are described in more detail below.

The mapping data engine 114 is configured to receive customer data specifying work tasks requested by the customer. For example, customer A may be a television cable provider engaging an information provider 118 (e.g., a call center service provider) to handle all of its installation appointment calls and conduct new service sales calls (i.e., work tasks). As such, the mapping data engine 114 receives the customer data from customer A specifying the work tasks as handling installation appointment calls and conducting new service sale calls.

The mapping data engine 114 is also configured to generate mapping data. The mapping data specify measures of correlation between the skills data of the service providers and the customer data specifying work tasks requested by the customer. For example, if the customer data specified a task for handling technical support service calls, the mapping data would include data indicating how well various service providers skillsets map to (correlate with) handling technical support service calls. If the service provider had previous technical support service call experience, the correlation measure specified by the mapping data would be high, indicating the service provider is likely well suited to the task. Conversely, if a service provider had no training or experience handling technical support service calls and had no other related skills or attributes (e.g., skills or attributes that would indicate the service provider could effectively handle technical support service calls such as previous non-technical call support experience or electronics repair certifications) then the correlation measure would be low, indicating the service provider is likely not well suited for the task.

The mapping data engine 114 is also configured to provide the mapping data to an information provider 118. In some implementations, the mapping data are used by the information provider 118 to map a service request to a service provider having a skillset highly correlated with the work tasks requested by the customer. For example, if a support call (e.g., the service request) for customer A is received by the information provider 118 (e.g., a call center), the information provider 118 can identify a service provider (e.g., a customer service representative) having a skillset well matched to the subject matter of the service request, and route the service request to that service provider to ensure the request is effectively handled.

The correlation data engine 116 is configured to receive selections of performance metrics from the performance data and skillsets or skills from the skills data. The received selections of performance metrics and skillsets are used by the correlation data engine 116 to generate correlations data for the metrics and skillsets. For example, the correlation data engine 116 can receive selections from an employer of service providers selecting a performance metric of service call handling efficiency (e.g., the average length of a service call) and skillsets of product A sales skill and product B sales skill. In some scenarios, there will be numerous selections of performance metrics and numerous selections of skillsets.

As described above, the correlation data engine 116 is configured to generate correlation data between the selected skillsets and each of the selected performance metrics. The correlation data specifies a correlation measure between the selected skillset and each of the selected performance metrics. For example, the received selections are service call handling efficiency, product A sales skill and product B sales skill. All service providers having product A sales skills have high service call handling efficiency ratings and some service providers having product B sales skills have low service call handling efficiency ratings while others have high ratings. As such, the correlation data would reflect a high correlation between product A sales skill and call handling efficiency and a lower correlation between product B sales skill and call handling efficiency (as some service providers having product B sales skills have high efficiency ratings and other service providers having product B sales skills have low ratings).

Analysis of the correlation data allow, for example, employers to determine what skillset(s) are associated with high performance levels for certain work tasks. Thus, if the employer desires to increase service call handling efficiency, the employer can, for example, identify those employees that have not been trained to sell product A and provide product A sales training to those employees.

Generation of the mapping data and the correlation data by the mapping data engine 114 and the correlation data engine 116, respectively, is described in more detail below.

Mapping Data Generation

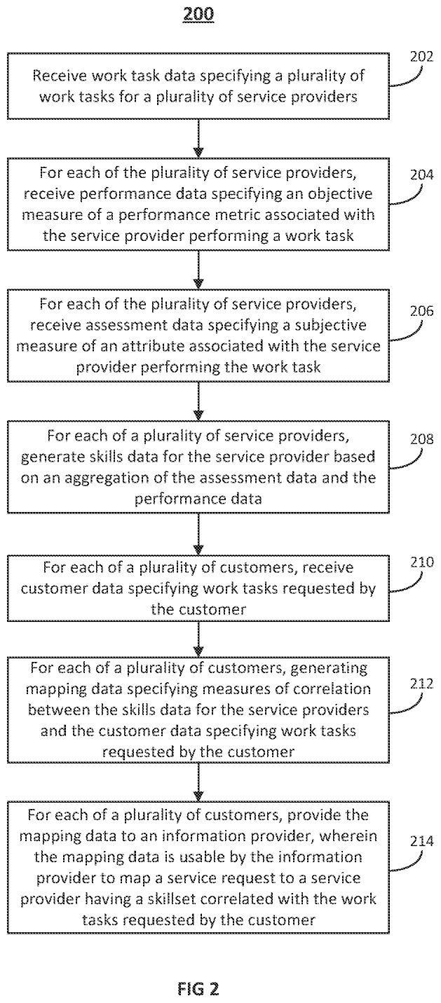

One example process by which the skills data processing system 100 generates and provides mapping data to information providers 118 is described in reference to FIG. 2, which is a flow diagram of an example process 200 for providing mapping data to information providers 118. The mapping data provided to the information provider, for example, can be used by the information provider to map service requests to service providers having skillsets well matched to requested work tasks. The process 200 can be implemented in one or more computer devices of the skills data processing system 100.

The process 200 receives work task data specifying a plurality of work tasks for a plurality of service providers (202). In some implementations, the task identification engine 110 receives the work task data. The task identification engine 110 can, for example, receive the work task data from service provider employers or directly from the service providers describing the job duties and roles of the service providers. The work task data describes the job duties of a particular type of job (e.g., carpenter, mechanic, customer service representative, etc.) or describe the job duties of a particular service provider (e.g., employee X).

The process 200, for each of the plurality of service providers, receives performance data specifying an objective measure of a performance metric associated with the service provider performing a work task (204). As described above, the objective measure of a performance metric is an empirically determined measure of the performance metric. The objective measure is, for example, verifiable such that the measure is unambiguous. In some implementations, the skills data engine 112 receives the performance data.

The process 200, for each of the plurality of service providers, receives assessment data specifying a subjective measure of an attribute associated with the service provider performing the work task (206). As described above, the subjective measure is a biased measure of the attribute. In some implementations, the skills data engine 112 receives the assessment data.

The process 200, for each of a plurality of service providers, generates skills data for the service provider based on an aggregation of the assessment data and the performance data (208). In some implementations, the skills data engine 112 generates the skills data. The skills data define a skillset of the service provider for a performance of the work task. As described above, the skillset represents the skills of a service provider (e.g., actual skills of an employee or desired skills with respect to a position or role). In an embodiment, skillsets comprise one or more skills. The skillsets for a particular service provider, or an agent, can be represented as a strand.

The importance of certain KPIs to a strand can be examined as follows. A variance model is outlined to determine the importance of certain KPIs to a strand. While automated, a user may still be allowed to select the KPIs they want to generate a strand with and the strand will be generated from those KPIs considering the normalized variance of each KPI (either over past data, or data from a data-lake). The variance model may be mathematically defined as:

$${σ}^{2} = \frac{\sum {X}^{2}}{N} - {μ}^{2}$$

Where μ is the mean over data set, X² represents the squared sum of the data set, N represents the size of the data set, and σ² represents the variance of each metric. The variances are then normalized against the other metrics used in the strand to calculate the importance of each metric as follows:

$${⋀}_{i = 0}^{N} \frac{{σ}_{i}^{2}}{{\sum }_{j = 1}^{N} α . ( {σ}_{j}^{2} )}$$

Where N represents the number of metrics, i represents a first metric and j represents a second metric. Weightings may also be applied to each metric depending on ranking by the user to allow a user more control over the system. This may be represented mathematically as:

$${⋀}_{i = 0}^{N} \frac{α . {σ}_{i}^{2}}{{\sum }_{j = 1}^{N} α . ( {σ}_{j}^{2} )}$$

Where 0≤α≥1 represents the metric weighting. A higher variance in the data set passed into the calculation results in that matric having a stronger weighting compared to metrics with smaller variance. As a result, the potential improvement of underperformers is maximized and strong performers are highlighted that stand out in important areas.

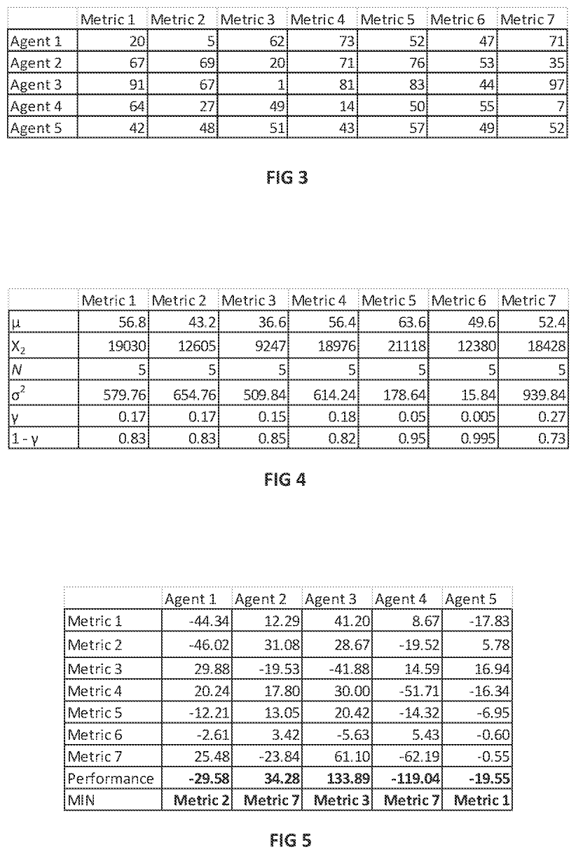

Strand generation may be generated on a random sample set as shown in FIG. 3, which exemplifies a plurality of agents and a plurality of metrics associated with each of the plurality of agents. In this example, for simplicity, 5 agents are illustrated in FIG. 3 with 7 metrics each. The generated strand will be used to test performance and improvements of the agents.

FIG. 4 is a table illustrating an example of determination of the strand, with γ representing the percentage each metric contributes to the strand. The inverse is represented as (1-γ) which may be used for performance calculations. The mean over the data set, the squared sums of the data set, the size of the data set, and the variances of each metric are also represented in FIG. 4 for each of the plurality of metrics from FIG. 3. The strand is thus generated using the y values from FIG. 4 as follows mathematically as:

0.17∩0.17∩0.15∩0.18∩0.05∩0.005∩0.27

In determining which metric to improve, the agent's distance from the mean is examined (to determine whether the agent is better or worse than average). The weighting of that metric is used in the strand and it is determined which of the metrics that agent should focus on improving. Consideration is given to the potential gain and difficulty of improvement as outlined by the strand determination above. Mathematically, this may be represented as:

$${min}_{α ∈ S} f ( \frac{α - μ}{1 - γ} )$$

Where S represents the set of the agent's metric values. For each metric that is maximized, the equation may be substituted with:

$${min}_{α ∈ S} f ( \frac{- α - μ}{1 - γ} )$$

The system may be mathematically run over sample data to determine the results and whether the resulting strands are suitable. These are tested against other agents' data to rank agents and even show mathematically where they can improve.

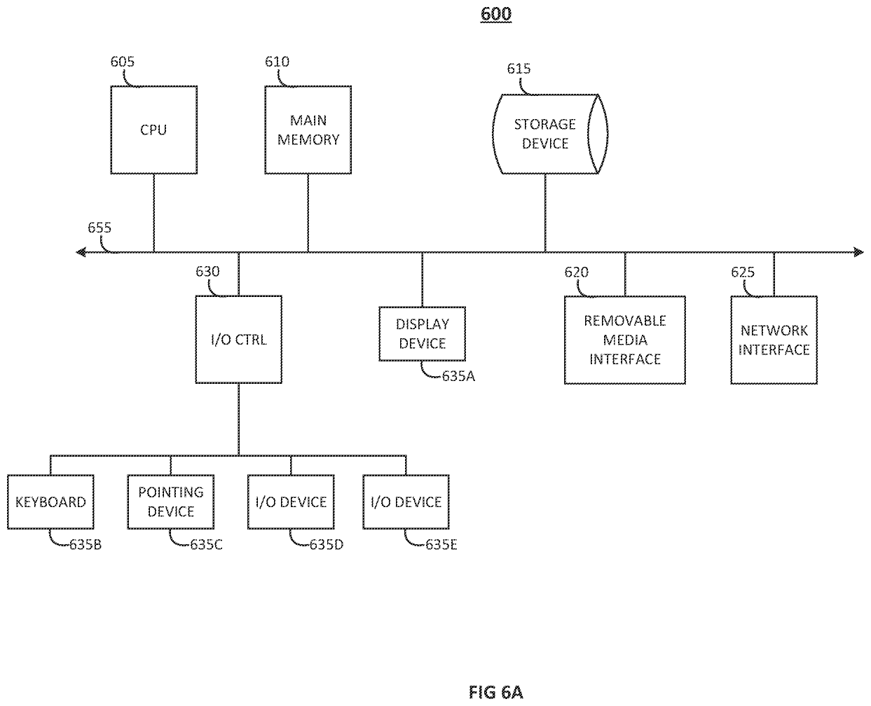

FIG. 5 illustrates the plurality of metrics and plurality of agents from FIG. 3 with performance determinations and which metrics the agent should focus on improving. Agent 1 is determined to focus on Metric 2, Agent 2 is determined to focus on Metric 7, and so forth. In an embodiment, the metrics can be ranked from 1-7, providing more flexibility on what to improve and when. In another embodiment, the user of the system is able to exercise personal preference. For example, the user may not want to spend time improving Metric 1, and the next best metric for an agent can be reselected (such as for Agent 5, Metric 4 from Metric 1, in FIG. 5).

In an embodiment, the variance analysis can be used to determine the effectiveness of learning items based on past data. Gathering data on users who have undertaken the learning items, and those who have not (or even the same data but before the learning item was taken), can show how well each learning item performs and the correct one can be chosen based on the variance currently in the dataset. This can be done through examining the comparison of the variance over the dataset, the mean, and the “tailed-ness” of the set.

In another embodiment, the variance between sets of users can attempt to find and solve issues certain groups are having, for instance, a low mean from employees in a certain office compared to other offices can attempt to bring up issues that certain areas are having.

In another embodiment, a low variance in certain metrics could indicate that the metric has not been correctly scored by the user, or that the metric is one that should be reconsidered.

The process 200, for each of a plurality of customers, receives customer data specifying work tasks requested by the customer (210). For example, the customer data are received from a manufacturer (i.e., the customer) employing a call center service provider to handle its sales calls. As described above, customer data specify work tasks requested by particular customers and required or desired attributes or performance levels associated with the requested work tasks. In some implementations, the mapping data engine 114 receives the customer data.

The process 200, for each of a plurality of customers, generates mapping data specifying measures of correlation between the skills data for the service providers and the customer data specifying work tasks requested by the customer (212). As described above, the mapping data specifies a measure of correlation between service provider skills (e.g., software troubleshooting proficiency or sales experience) and work-related tasks or duties (e.g., such as those requested by customers).

The process 200, for each of a plurality of customers, provides the mapping data to an information provider (214). The mapping data are usable by an information provider 118 to map a service request to a service provider having a skillset correlated with the work tasks requested by the customer. The information provider 118 (e.g., call center service provider) can, for example, use the mapping data to map service requests (e.g., customer service calls) to service providers having skillsets well matched (e.g., highly correlated) to the subject matter of the service requests. For example, a consumer may call a customer service center seeking assistance with the setup of a recently purchased television (e.g., via a telephonic menu, through which the consumer specifies product/problems being experience). The call center receiving the request can utilize the mapping data to route the incoming call to a customer service support specialist knowledgeable about television setups, as opposed to a support specialist having little experience with television setups. Routing the call to a knowledgeable support specialist enhances the customer experience because the customer receives assistance from a subject matter expert.

Additionally, the mapped routing process benefits the call center as the call is handled in a time-efficient manner (e.g., the call is not arbitrarily bounced from one support specialist to the next attempting to identify a specialist that can handle the call), and benefits the manufacturer of the television as the customer has a positive support experience with a knowledgeable support specialist.

Correlation Data Generation

As described above, the skills data are used to generate mapping data. In addition, the skills data processing system 100 can also use the skills data to generate correlation data. One example process by which the skills data processing system 100 generates correlation data can be described as follows.

Skills data for service providers is received in the system 100. In an embodiment, the correlation data engine 116 receives the skills data from the skills data engine 112. Performance and assessment data may also be received. Skills data is generated for service providers based on the performance and assessment data in a manner similar to that described above with reference to the process 200.

Selections of performance metrics are received from performance data and skillsets from the skill data. In an embodiment, the correlation data engine 116 receives the selections of performance metrics and skillsets. For example, the received selections could be selections from an employer based on skills data and performance metrics associated with the employer's employees. The received selections of skillsets or skills are, for example, skills represented by the strands described previously.

Correlation data is generated for each of the selected skillsets between the selected skillset from the skills data and each of the selected performance metrics. The correlation data for the selected skillset specifies a correlation measure between the selected skillset and each of the selected performance metrics. For example, if employees with high skillset scores have high performance levels, then the correlation data would indicate a strong correlation between those skills and that performance metric. On the other hand, if half of the employees with high skillset scores have low performance levels and the other half have high performance levels, then the correlation data indicates a weak correlation between those skills and that performance metric.

Generally, correlation measures indicate which skillsets affect which performance metrics. In embodiment, the correlation data engine 116 identifies a skillset and performance metric pair having correlation measures that exceed a threshold. For example, if an employer desires to identify skills or skillsets that increase a certain performance metric associated with a work task (e.g., a particular product's sales), then the employer can set a correlation threshold defining a minimum correlation measure such that the correlation data engine 116 will only identify or highlight skills or skillsets that have correlation measures with the performance metric greater than the threshold.

In an embodiment, skillset scores or strands for a service provider or group of service providers can be tracked during time periods to provide insight into changes in service provider performance over time. For example, service provider skillset scores may change during a given time period based on changes in work task performance levels of the service provider (e.g., by gaining experience or receiving additional work task-related training) or the receipt of additional managerial reviews (e.g., assessment data) for the service provider.

Computer Systems

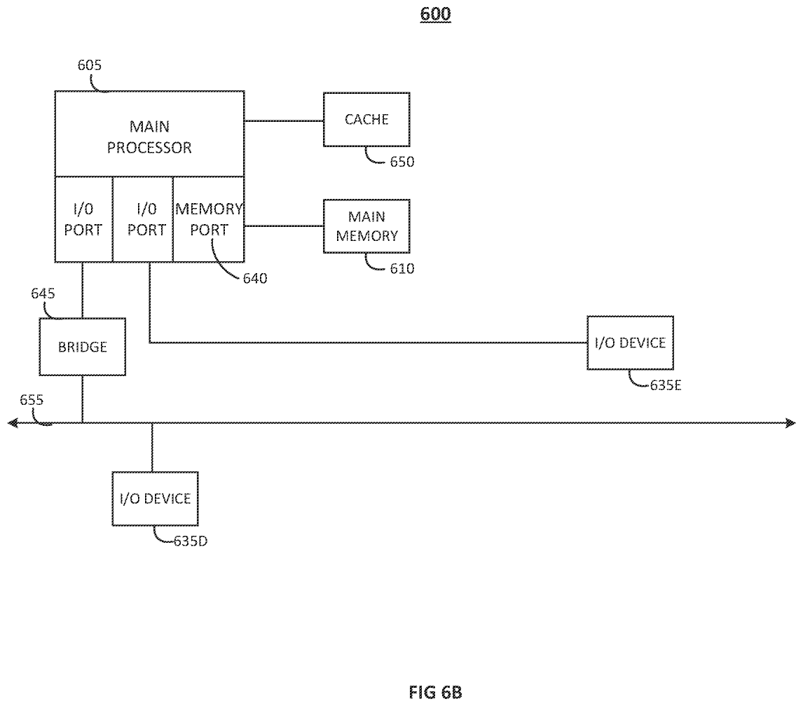

In an embodiment, each of the various servers, controls, switches, gateways, engines, and/or modules (collectively referred to as servers) in the described figures are implemented via hardware or firmware (e.g., ASIC) as will be appreciated by a person of skill in the art. Each of the various servers may be a process or thread, running on one or more processors, in one or more computing devices (e.g., FIGS. 6A, 6B), executing computer program instructions and interacting with other system components for performing the various functionalities described herein. The computer program instructions are stored in a memory which may be implemented in a computing device using a standard memory device, such as, for example, a RAM. The computer program instructions may also be stored in other non-transitory computer readable media such as, for example, a CD-ROM, a flash drive, etc. A person of skill in the art should recognize that a computing device may be implemented via firmware (e.g., an application-specific integrated circuit), hardware, or a combination of software, firmware, and hardware. A person of skill in the art should also recognize that the functionality of various computing devices may be combined or integrated into a single computing device, or the functionality of a particular computing device may be distributed across one or more other computing devices without departing from the scope of the exemplary embodiments of the present invention. A server may be a software module, which may also simply be referred to as a module. The set of modules in the contact center may include servers, and other modules.

The various servers may be located on a computing device on-site at the same physical location as the agents of the contact center or may be located off-site (or in the cloud) in a geographically different location, e.g., in a remote data center, connected to the contact center via a network such as the Internet. In addition, some of the servers may be located in a computing device on-site at the contact center while others may be located in a computing device off-site, or servers providing redundant functionality may be provided both via on-site and off-site computing devices to provide greater fault tolerance. In some embodiments, functionality provided by servers located on computing devices off-site may be accessed and provided over a virtual private network (VPN) as if such servers were on-site, or the functionality may be provided using a software as a service (SaaS) to provide functionality over the internet using various protocols, such as by exchanging data using encoded in extensible markup language (XML) or JSON.

FIGS. 6A and 6B are diagrams illustrating an embodiment of a computing device as may be employed in an embodiment of the invention, indicated generally at 600. Each computing device 600 includes a CPU 605 and a main memory unit 610. As illustrated in FIG. 6A, the computing device 600 may also include a storage device 615, a removable media interface 620, a network interface 625, an input/output (I/O) controller 630, one or more display devices 635A, a keyboard 635B and a pointing device 635C (e.g., a mouse). The storage device 615 may include, without limitation, storage for an operating system and software. As shown in FIG. 6B, each computing device 600 may also include additional optional elements, such as a memory port 640, a bridge 645, one or more additional input/output devices 635D, 635E, and a cache memory 650 in communication with the CPU 605. The input/output devices 635A, 635B, 635C, 635D, and 635E may collectively be referred to herein as 635.

The CPU 605 is any logic circuitry that responds to and processes instructions fetched from the main memory unit 610. It may be implemented, for example, in an integrated circuit, in the form of a microprocessor, microcontroller, or graphics processing unit, or in a field-programmable gate array (FPGA) or application-specific integrated circuit (ASIC). The main memory unit 610 may be one or more memory chips capable of storing data and allowing any storage location to be directly accessed by the central processing unit 605. As shown in FIG. 6A, the central processing unit 605 communicates with the main memory 610 via a system bus 655. As shown in FIG. 6B, the central processing unit 605 may also communicate directly with the main memory 610 via a memory port 640.

In an embodiment, the CPU 605 may include a plurality of processors and may provide functionality for simultaneous execution of instructions or for simultaneous execution of one instruction on more than one piece of data. In an embodiment, the computing device 600 may include a parallel processor with one or more cores. In an embodiment, the computing device 600 comprises a shared memory parallel device, with multiple processors and/or multiple processor cores, accessing all available memory as a single global address space. In another embodiment, the computing device 600 is a distributed memory parallel device with multiple processors each accessing local memory only. The computing device 600 may have both some memory which is shared and some which may only be accessed by particular processors or subsets of processors. The CPU 605 may include a multicore microprocessor, which combines two or more independent processors into a single package, e.g., into a single integrated circuit (IC). For example, the computing device 600 may include at least one CPU 605 and at least one graphics processing unit.

In an embodiment, a CPU 605 provides single instruction multiple data (SIMD) functionality, e.g., execution of a single instruction simultaneously on multiple pieces of data. In another embodiment, several processors in the CPU 605 may provide functionality for execution of multiple instructions simultaneously on multiple pieces of data (MIMD). The CPU 605 may also use any combination of SIMD and MIMD cores in a single device.

FIG. 6B depicts an embodiment in which the CPU 605 communicates directly with cache memory 650 via a secondary bus, sometimes referred to as a backside bus. In other embodiments, the CPU 605 communicates with the cache memory 650 using the system bus 655. The cache memory 650 typically has a faster response time than main memory 610. As illustrated in FIG. 6A, the CPU 605 communicates with various I/O devices 635 via the local system bus 655. Various buses may be used as the local system bus 655, including, but not limited to, a Video Electronics Standards Association (VESA) Local bus (VLB), an Industry Standard Architecture (ISA) bus, an Extended Industry Standard Architecture (EISA) bus, a Micro Channel Architecture (MCA) bus, a Peripheral Component Interconnect (PCI) bus, a PCI Extended (PCI-X) bus, a PCI-Express bus, or a NuBus. For embodiments in which an I/O device is a display device 635A, the CPU 605 may communicate with the display device 635A through an Advanced Graphics Port (AGP). FIG. 6B depicts an embodiment of a computer 600 in which the CPU 605 communicates directly with I/O device 635E. FIG. 6B also depicts an embodiment in which local buses and direct communication are mixed: the CPU 605 communicates with I/O device 635D using a local system bus 655 while communicating with I/O device 635E directly.

A wide variety of I/O devices 635 may be present in the computing device 600. Input devices include one or more keyboards 635B, mice, trackpads, trackballs, microphones, and drawing tables, to name a few non-limiting examples. Output devices include video display devices 635A, speakers and printers. An I/O controller 630 as shown in FIG. 6A, may control the one or more I/O devices, such as a keyboard 635B and a pointing device 635C (e.g., a mouse or optical pen), for example.

Referring again to FIG. 6A, the computing device 600 may support one or more removable media interfaces 620, such as a floppy disk drive, a CD-ROM drive, a DVD-ROM drive, tape drives of various formats, a USB port, a Secure Digital or COMPACT FLASH™ memory card port, or any other device suitable for reading data from read-only media, or for reading data from, or writing data to, read-write media. An I/O device 635 may be a bridge between the system bus 655 and a removable media interface 620.

The removable media interface 620 may, for example, be used for installing software and programs. The computing device 600 may further include a storage device 615, such as one or more hard disk drives or hard disk drive arrays, for storing an operating system and other related software, and for storing application software programs. Optionally, a removable media interface 620 may also be used as the storage device. For example, the operating system and the software may be run from a bootable medium, for example, a bootable CD.

In an embodiment, the computing device 600 may include or be connected to multiple display devices 635A, which each may be of the same or different type and/or form. As such, any of the I/O devices 635 and/or the I/O controller 630 may include any type and/or form of suitable hardware, software, or combination of hardware and software to support, enable or provide for the connection to, and use of, multiple display devices 635A by the computing device 600. For example, the computing device 600 may include any type and/or form of video adapter, video card, driver, and/or library to interface, communicate, connect or otherwise use the display devices 635A. In an embodiment, a video adapter may include multiple connectors to interface to multiple display devices 635A. In another embodiment, the computing device 600 may include multiple video adapters, with each video adapter connected to one or more of the display devices 635A. In other embodiments, one or more of the display devices 635A may be provided by one or more other computing devices, connected, for example, to the computing device 600 via a network. These embodiments may include any type of software designed and constructed to use the display device of another computing device as a second display device 635A for the computing device 600. One of ordinary skill in the art will recognize and appreciate the various ways and embodiments that a computing device 600 may be configured to have multiple display devices 635A.

An embodiment of a computing device indicated generally in FIGS. 6A and 6B may operate under the control of an operating system, which controls scheduling of tasks and access to system resources. The computing device 600 may be running any operating system, any embedded operating system, any real-time operating system, any open source operation system, any proprietary operating system, any operating systems for mobile computing devices, or any other operating system capable of running on the computing device and performing the operations described herein.

The computing device 600 may be any workstation, desktop computer, laptop or notebook computer, server machine, handled computer, mobile telephone or other portable telecommunication device, media playing device, gaming system, mobile computing device, or any other type and/or form of computing, telecommunications or media device that is capable of communication and that has sufficient processor power and memory capacity to perform the operations described herein. In some embodiments, the computing device 600 may have different processors, operating systems, and input devices consistent with the device.

In other embodiments, the computing device 600 is a mobile device. Examples might include a Java-enabled cellular telephone or personal digital assistant (PDA), a smart phone, a digital audio player, or a portable media player. In an embodiment, the computing device 600 includes a combination of devices, such as a mobile phone combined with a digital audio player or portable media player.

A computing device 600 may be one of a plurality of machines connected by a network, or it may include a plurality of machines so connected. A network environment may include one or more local machine(s), client(s), client node(s), client machine(s), client computer(s), client device(s), endpoint(s), or endpoint node(s) in communication with one or more remote machines (which may also be generally referred to as server machines or remote machines) via one or more networks. In an embodiment, a local machine has the capacity to function as both a client node seeking access to resources provided by a server machine and as a server machine providing access to hosted resources for other clients. The network may be LAN or WAN links, broadband connections, wireless connections, or a combination of any or all of the above. Connections may be established using a variety of communication protocols. In one embodiment, the computing device 600 communicates with other computing devices 600 via any type and/or form of gateway or tunneling protocol such as Secure Socket Layer (SSL) or Transport Layer Security (TLS). The network interface may include a built-in network adapter, such as a network interface card, suitable for interfacing the computing device to any type of network capable of communication and performing the operations described herein. An I/O device may be a bridge between the system bus and an external communication bus.

In an embodiment, a network environment may be a virtual network environment where the various components of the network are virtualized. For example, the various machines may be virtual machines implemented as a software-based computer running on a physical machine. The virtual machines may share the same operating system. In other embodiments, different operating system may be run on each virtual machine instance. In an embodiment, a “hypervisor” type of virtualizing is implemented where multiple virtual machines run on the same host physical machine, each acting as if it has its own dedicated box. The virtual machines may also run on different host physical machines.

Other types of virtualization are also contemplated, such as, for example, the network (e.g., via Software Defined Networking (SDN)). Functions, such as functions of session border controller and other types of functions, may also be virtualized, such as, for example, via Network Functions Virtualization (NFV).

In an embodiment, the use of LSH to automatically discover carrier audio messages in a large set of pre-connected audio recordings may be applied in the support process of media services for a contact center environment. For example, this can assist with the call analysis process for a contact center and removes the need to have humans listen to a large set of audio recordings to discover new carrier audio messages.

While the invention has been illustrated and described in detail in the drawings and foregoing description, the same is to be considered as illustrative and not restrictive in character, it being understood that only the preferred embodiment has been shown and described and that all equivalents, changes, and modifications that come within the spirit of the invention as described herein and/or by the following claims are desired to be protected.

Hence, the proper scope of the present invention should be determined only by the broadest interpretation of the appended claims so as to encompass all such modifications as well as all relationships equivalent to those illustrated in the drawings and described in the specification.

1. A computer-implemented method for selectively routing by a routing server an incoming service request at a contact center in accordance with strands of key performance indicators and improvement profiles that are automatically generated for agents of the contact center by a server configured as a skills management platform, wherein the agents of the contact center include an agent and other agents, and the key performance indicators are defined as metrics used by the contact center for comparing agent performance, the method comprising the steps of:
measuring, during prior interactions with customers handled by each of the agents, the metrics of the key performance indicators, and storing the measured metrics as past data for each of the agents in a data store;
receiving, by the skills management platform via a network connecting the skills management platform to the data store, the past data for each of the agents;
generating, by the skills management platform, the strand, the strand comprising the metrics of the key performance indicators and a weighting associated with each of the metrics, wherein the skills management platform generates the weightings by:
determining a variance for each metric and the past data for the metric;
normalizing the determined variances for the metrics;
comparing the normalized variances of the metrics and, based thereon, determining an importance for each of the metrics such that the importance is directly proportional to the normalized variance of a given metric relative to other ones of the metrics; and
determining the weighting for each of the metrics according to the determined importance;
generating, by the skills management platform, the improvement profile for the agent that identifies one or more improvement metrics of the metrics for improvement by the agent and a skillset for the agent, wherein the skills management platform generates the improvement profile for the agent by:
calculating a mean for each metric, wherein the mean is calculated using the past data for all of the agents for each of the metrics;
calculating a distance from the mean for each of the metrics for the agent and comparing the resulting distances for the agent with corresponding distances calculated for the other agents;
ranking the agent against the other agents in relation to performance in each of the metrics given the comparison of the distances; and
generating the improvement profile based on the ranking of the agent for each of the metrics and the weightings of each of the metrics in the strand;
selectively routing by the routing server the incoming service request to the agent based on the generated improvement profile by:
receiving the service request for routing to one of the agents, wherein the service request includes mapping data that defines work tasks for calculating a degree of correlation with a skillset of a given agent;
calculating a degree of correlation between the generated skillset of the agent and a generated skillset of at least one of the other agents and the work tasks of the service request and, based on the degree of correlation calculated for the agent being higher than the degree of correlation for the at least one of the other agents, selecting the agent for handling the service request; and
in response to the selection of the agent, routing the service request a device associated with the agent for handling thereby.

2. The method of claim 1, wherein the direct proportionality between the normalized variance and the importance of the metrics comprises a metric with a higher variance having a higher importance than a metric with a lower variance.

3. The method of claim 1, wherein the identifying the one or more improvement metrics further comprises considering potential gain and difficulty of improvement of the metric.

4. The method of claim 1, wherein the step of generating the one or more improvement metrics of the improvement profile further comprises mathematically calculating a minimum over the metrics for the agent.

5. The method of claim 1, further comprising the step of comparing the resulting distances for the agent against corresponding respective threshold distances;
wherein the step of generating the one or more improvement metrics of the improvement profile further comprises identifying ones of the metrics in which the resulting distance for the agent failed to satisfy the corresponding threshold distance.

6. The method of claim 1, wherein the step of normalizing comprises:
$${⋀}_{i = 0}^{N} \frac{α . {σ}_{i}^{2}}{{\sum }_{j = 1}^{N} α . ( {σ}_{j}^{2} )}$$
in which:
N is equal to a number of the metrics;
0≤α≥1 is equal to the weighting of the metric;
σ² is equal to the variance of the metric;
i represents a first metric of the metrics; and
j represents a second metric of the metrics.

7. The method of claim 1, further comprising the step of communicating to the agent the one or more improvement metrics of the improvement profile through a user interface associated with the skills management platform one the device associated with the agent.

8. A system for selectively routing by a routing server an incoming service request at a contact center in accordance with strands of key performance indicators and improvement profiles that are automatically generated for agents of the contact center by a server configured as a skills management platform, wherein the agents of the contact center include an agent and other agents, and the key performance indicators are defined as metrics used by the contact center for comparing agent performance, the system comprising:
the skills management platform;
the routing server;
a processor; and
a memory in communication with the processor, the memory storing instructions that, when executed by the processor, cause the processor to perform the following steps:
measuring, during prior interactions with customers handled by each of the agents, the metrics of the key performance indicators, and storing the measured metrics as past data for each of the agents in a data store;
receiving, by the skills management platform via a network connecting the skills management platform to the data store, the past data for each of the agents;
generating, by the skills management platform, the strand, the strand comprising the metrics of the key performance indicators and a weighting associated with each of the metrics, wherein the skills management platform generates the weightings by:
determining a variance for each metric and the past data for the metric;
normalizing the determined variances for the metrics;
comparing the normalized variances of the metrics and, based thereon, determining an importance for each of the metrics such that the importance is directly proportional to the normalized variance of a given metric relative to other ones of the metrics; and
determining the weighting for each of the metrics according to the determined importance;
generating, by the skills management platform, the improvement profile for the agent that identifies one or more improvement metrics of the metrics for improvement by the agent and a skillset for the agent, wherein the skills management platform generates the improvement profile for the agent by:
calculating a mean for each metric, wherein the mean is calculated using the past data for all of the agents for each of the metrics;
calculating a distance from the mean for each of the metrics for the agent and comparing the resulting distances for the agent with corresponding distances calculated for the other agents;
ranking the agent against the other agents in relation to performance in each of the metrics given the comparison of the distances; and
generating the improvement profile based on the ranking of the agent for each of the metrics and the weightings of each of the metrics in the strand;
selectively routing by the routing server the incoming service request to the agent based on the generated improvement profile by:
receiving the service request for routing to one of the agents, wherein the service request includes mapping data that defines work tasks for calculating a degree of correlation with a skillset of a given agent;
calculating a degree of correlation between the generated skillset of the agent and a generated skillset of at least one of the other agents and the work tasks of the service request and, based on the degree of correlation calculated for the agent being higher than the degree of correlation for the at least one of the other agents, selecting the agent for handling the service request; and
in response to the selection of the agent, routing the service request a device associated with the agent for handling thereby.

9. The system of claim 8, wherein the direct proportionality between the normalized variance and the importance of the metrics comprises a metric with a higher variance having a higher importance than a metric with a lower variance.

10. The system of claim 8, wherein the identifying the one or more improvement metrics further comprises considering potential gain and difficulty of improvement of the metric.

11. The system of claim 8, wherein the instructions further cause the processor to perform the step of:
generating the one or more improvement metrics of the improvement profile further comprises mathematically calculating a minimum over the metrics for the agent.

12. The system of claim 8, further wherein the instructions further cause the processor to perform the step of:
comparing the resulting distances for the agent against corresponding respective threshold distances;
wherein the step of generating the one or more improvement metrics of the improvement profile further comprises identifying ones of the metrics in which the resulting distance for the agent failed to satisfy the corresponding threshold distance.

13. The system of claim 8, wherein the step of normalizing comprises:
$${⋀}_{i = 0}^{N} \frac{α . {σ}_{i}^{2}}{{\sum }_{j = 1}^{N} α . ( {σ}_{j}^{2} )}$$
in which:
N is equal to a number of the metrics;
0≤α≥1 is equal to the weighting of the metric;
σ² is equal to the variance of the metric;
i represents a first metric of the metrics; and
j represents a second metric of the metrics.

14. The system of claim 8, wherein the instructions further cause the processor to perform the step of:
communicating to the agent the one or more improvement metrics of the improvement profile through a user interface associated with the skills management platform one the device associated with the agent.
